(19) United States
(12) Patent Application Publication
(10) Pub. No.: US 2008/0239301 A1
(43) Pub. Date: Oct. 2, 2008

(54) Visual inspection apparatus

(75) Inventors: Atsutoshi Yokota, Kamiina-gun (JP); Shunsuke Kurata, Kamiina-gun (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/079,261

(22) Filed: Mar. 26, 2008

(30) Foreign Application Priority Data
Mar. 27, 2007 (JP) P2007-080546

(51) Int. Cl. G01N 21/88

(52) U.S. Cl. 356/237.2

(57) ABSTRACT

A visual inspection apparatus includes an upper illuminator, a lower illuminator, a side illuminator, and a pair of inclined illuminators, which illuminate the peripheral edge of a wafer, and illuminates the peripheral edge of the wafer brightly. A gap is formed in the upper illuminator and illumination light of an epi-illumination portion is injected through the gap. The illumination light of the epi-illumination portion is refracted and reflected by a first mirror to illuminate the peripheral edge of the wafer. The illumination position is changed by moving second mirrors together as needed. An image of the peripheral edge is acquired in an imaging portion disposed at the same axis as the epi-illumination portion.

### BACKGROUND OF THE INVENTION

1. Field of the Invention

The present invention relates to a visual inspection apparatus that performs visual inspection of a peripheral edge of a work, such as a wafer. Priority is claimed on Japanese Patent Application No. 2007-80546, filed Mar. 27, 2007, the content of which is incorporated herein by reference.

2. Description of Related Art

When forming a pattern, such as a circuit, in a work, such as a semiconductor wafer, warpage or internal stress may occur in the work due to heat treatment. The work may crack while a circuit is being manufactured if the warpage or the internal stress of the work increases. Therefore, a technique of detecting the existence of a crack for which cracking may progress in the future by observing the peripheral edge of the work beforehand is known.

An apparatus for observing the peripheral edge of a work includes an apparatus in which a C-shaped illumination portion is provided adjacent to the peripheral edge of the work and an imaging camera is provided at a position distant from the work and the illumination portion, for example, as disclosed in Japanese Patent Application, First Publication No. 2003-243465. The illumination portion forms an illuminated surface along a predetermined arc in the thickness direction of the peripheral edge of the work and emits illumination light such that light converges toward the middle of the arc. The imaging camera is disposed so as to be located in a bright field range of reflected light of the illumination light from the illumination portion.

However, in the known apparatus configuration, it was not possible to obtain an image if the imaging camera was not provided in a bright field range. For this reason, the observable range was narrow.

Since it is difficult to illuminate a work brightly in a wide range in the known illumination portion, observing in the bright field cannot be satisfactorily performed if the imaging camera is moved.

In order to observe and analyze the peripheral edge of the work in detail, it is preferable to perform observing in a dark field. However, it was not possible to perform observing in the dark field in the known apparatus configuration.

### SUMMARY OF THE INVENTION

Therefore, the invention has been finalized in view of the above problem, and it is an object of the invention to make it possible to perform satisfactory bright field observing in a wide region. Furthermore, it is another object of the invention to make it possible to perform observing in a dark field.

According to an aspect of the invention, a visual inspection apparatus includes: a peripheral edge observation device that observes a peripheral edge of a work supported by a support portion; and a peripheral edge illuminating device that illuminates a position of observing performed by the peripheral edge observation device. The peripheral edge illuminating device has a plurality of surface light sources that illuminate the peripheral edge of the work located at the observation position, and the surface light sources are disposed at upper, lower, and side positions from the peripheral edge of the work located at the observation position so as to surround the peripheral edge of the work.

In this visual inspection apparatus, when the plurality of surface light sources disposed to surround the peripheral edge of the work are turned on, the work is illuminated from the upper, lower, and side directions of the peripheral edge of the work. The peripheral edge observation device observes the peripheral edge of the work illuminated from different directions.

In the invention, since the peripheral edge of the work can be brightly illuminated by the plurality of surface light sources, a clear image can be obtained even if the position observed by the peripheral edge observation device changes.

The above, other objects, and operations and effects of the invention will become apparent to those skilled in the art from the accompanying drawings and an embodiment of the invention.

### BRIEF DESCRIPTION OF THE DRAWINGS

FIG. 1 is a view illustrating the schematic configuration of a visual inspection apparatus according to an embodiment of the invention;

FIG. 2 is a plan view taken along the line II-II of FIG. 1;

FIG. 3 is a side view taken along the line III-III of FIG. 2,

FIG. 4 is a view illustrating a state when observing a side surface of a wafer;

FIG. 5 is a view illustrating a state when observing an upper surface of a wafer;

FIG. 6 is a view illustrating a state when observing a bottom surface of a wafer;

FIG. 7 is a view from an arrow C in FIG. 2; and

FIG. 8 is a view illustrating a modified example of a peripheral edge observation device.

### BRIEF DESCRIPTION OF THE REFERENCE SYMBOLS

1, 71—Visual Inspection Apparatus

3—XYθ stage

3A—Support Portion

5—Peripheral Edge Observation Device

6—Peripheral Edge illuminating Device

14—First Mirror (Optical Member)

21—Upper illuminator (Surface Light Source)

21A—Hole (Gap)

21B, 22B, 23B—Light Emitting Surface

22—Lower Illuminator (Surface Light Source)

23—Side Illuminator (Surface Light Source)

25—Space

W—Wafer (Work)

### DETAILED DESCRIPTION OF THE INVENTION

Hereinafter, a preferred embodiment for executing the invention will be described in detail with reference to the accompanying drawings. However, it is needless to say that the invention is not limited to the embodiment.

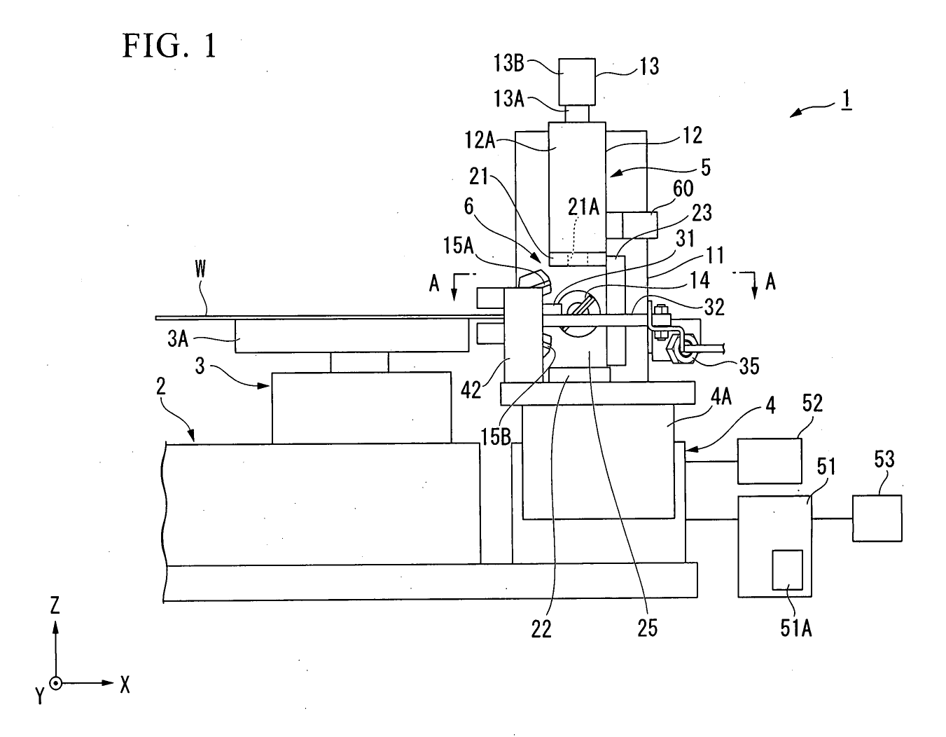

As shown in FIG. 1, a visual inspection apparatus 1 is provided with an XYθ stage 3 for absorbing and holding a wafer W, which is a work, on a base 2, and a Z stage 4.

The XYθ stage 3 has a support portion 3A that supports the wafer W, and an absorbing portion (not shown) that absorbs and holds a middle part of a bottom surface of the wafer W is provided in the support portion 3A. The XYθ stage 3 is configured to be able to move the support portion 3A in two directions (X direction and Y direction) perpendicular to each other in the horizontal direction and to rotate the support portion 3A in a Z-axis direction perpendicular to the X and Y directions. Driving of the XYθ stage 3 is controlled by a motor (not shown). As the motor, a motor that can perform precise positioning, such as a servo motor or a stepping motor, is used.

A precise stage that moves a slider 4A up and down in the Z direction by motor driving is used as the Z stage 4. The motor used for the Z stage 4 is also a motor that can perform precise positioning as described above. A peripheral edge observation device S and a peripheral edge illuminating device 6 are mounted on the slider 4A of the Z stage 4.

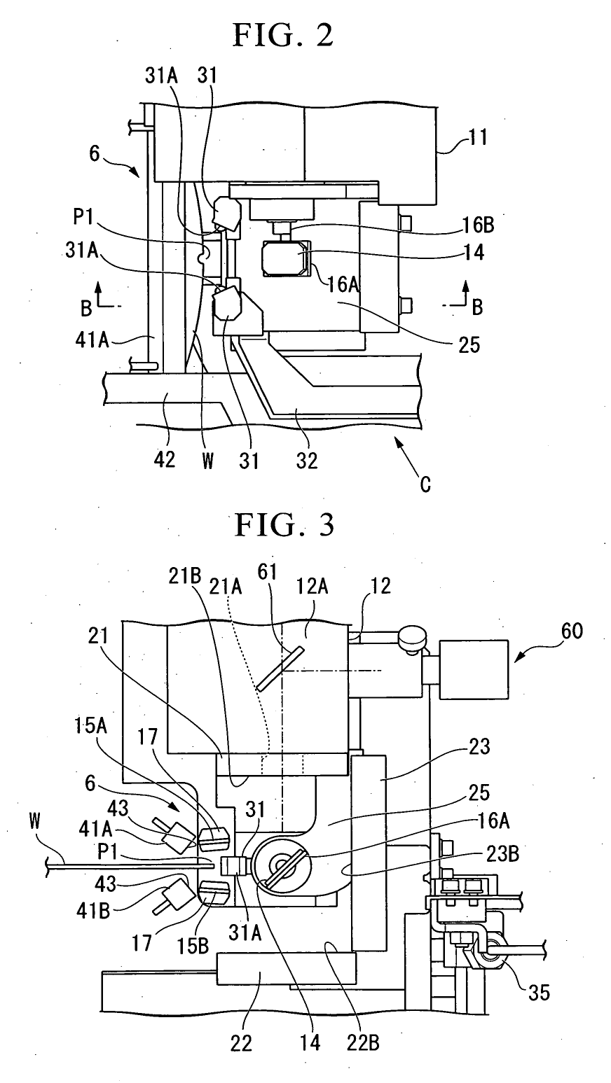

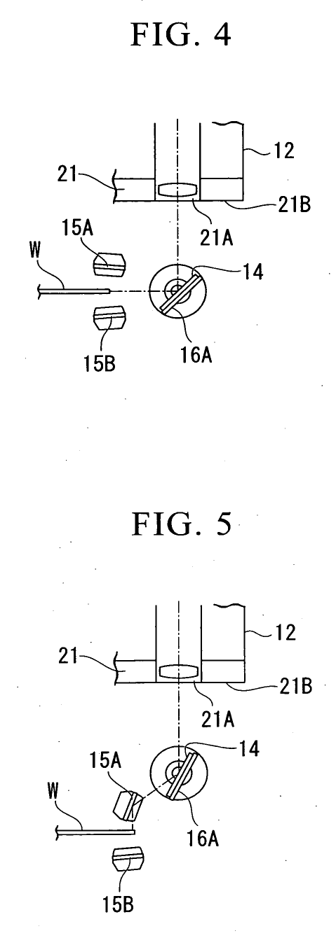

The peripheral edge observation device 5 includes: a fixed portion 11 fixed to the slider 4A of the Z stage 4; an observation optical system 12 supported upward from the wafer W by the fixed portion 11; and an imaging portion 13 that is disposed above the observation optical system 12 and has an imaging element with an imaging surface disposed in parallel with a main surface of the wafer W. In addition, the peripheral edge observation device 5 includes an epi-illumination portion 60 for providing illumination light from the observation optical system 12 to the wafer W on the same axis. The illumination light from the epi-illumination portion 60 is illuminated on the same axis by a half mirror 61 provided in the middle of the observation optical system 12. In addition, one first mirror 14 and two second mirrors 15A and 15B are provided before the optical axis. As shown in FIGS. 1 and 2, the first mirror 14 is supported by the fixed portion 11 on the optical axis of the observation optical system 12 so as to be movable and rotatable by a cam mechanism or the like. A rotating shaft 16B of a holder 16A that holds the first mirror 14 is parallel to the main surface of the wafer W and is set in a direction perpendicular to the optical axis of the observation optical system 12. Three mirrors 14, 15A, and 15B are configured to move and rotate integrally with the observation optical system 12 such that a working distance (hereinafter, referred to as ‘WD’) is always fixed by a cam mechanism (not shown) or the like and the optical axis does not deviate. Thus, when the rotating shaft 16B is made to rotate by a motor (not shown), it is possible to cause illumination light of the epi-illumination portion 60 to be refracted and reflected from the first mirror 14 toward the peripheral edge of the wafer W and upper and lower regions of the wafer W. In addition, in FIG. 3, the first mirror 14 is positioned to be inclined by 45° with respect to the optical axis of the observation optical system 12. As shown in FIG. 4, when the first mirror 14 is positioned to view the side surface of the wafer W, the side surface of the peripheral edge of the wafer W can be observed. In the case when an angle (observation angle) at which the optical axis faces the wafer W is set to 0° in side view, in the range of an observation angle of ±45°, the first mirror 14 rotates while moving integrally with the observation optical system 12 such that the WD is maintained constant in a plane parallel with the plane of FIG. 4, and thereby performing observing.

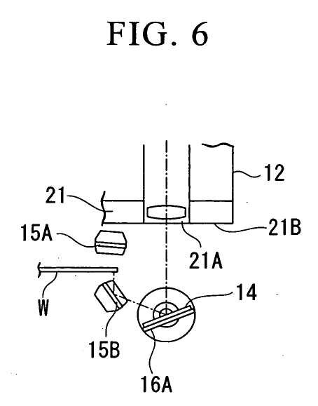

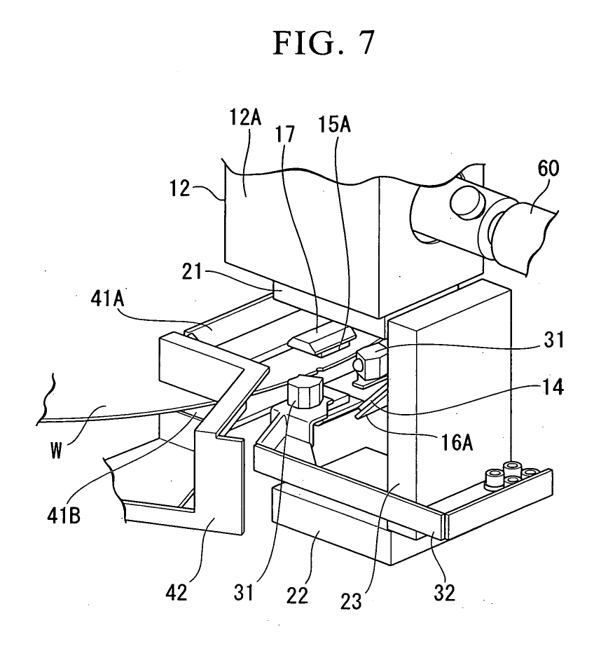

As shown in FIGS. 3, 5, and 6, the second mirrors 15A and 15B are disposed above and below the peripheral edge of the wafer W, respectively, so as to be separated by the same distance from the wafer W. In side view, one second mirror 15A and one second mirror 15B are disposed above and below the first mirror 14, respectively, and are disposed approximately horizontally so as not to lower optical performance due to being reflected on an imaging screen. The second mirrors 15A and 15B are configured to be able to change the inclination angle with a holder 17 provided in the fixed portion 11 when the observation angle of ±45° is exceeded. As shown in FIG. 5, when an observation is performed from above the wafer W, the inclination angle of the second mirror 15A is changed to an angle allowing a top surface side of the peripheral edge of the wafer W to be observed when the optical axis of the observation optical system 12 is bent at the first mirror 14 in conjunction with a cam mechanism or the like of the first mirror 14. Similarly, as shown in FIG. 6, when observing is performed from below the wafer W, the inclination angle of the second mirror 15B is changed to an angle allowing a bottom surface side of the peripheral edge of the wafer W to be observed when illumination light of the observation optical system 12 is refracted and reflected by the first mirror 14.

As shown in FIG. 1, the imaging portion 13 is configured to include an imaging lens 13A and a CCD (charge coupled device) camera 13B. The CCD camera 13B is connected to a monitor (not shown) and can display a peripheral edge image of the wafer W on the monitor.

As shown in FIG. 2 and FIG. 3, the peripheral edge illuminating device 6 includes an upper illuminator 21 fixed to a bottom surface of a cover 12A of the observation optical system 12 of the peripheral edge observation device 5, a lower illuminator 22 disposed opposite the upper illuminator 21, and a side illuminator 23 that is disposed in a direction perpendicular to the upper illuminator 21 and the lower illuminator 22 and is fixed at a position opposite the wafer W with the first mirror 14 interposed therebetween.

The upper illuminator 21 is disposed to be higher than the wafer W and the upper second mirror 15A by a predetermined distance in side view and has a ring shape having a hole 21A provided in the middle. The hole 21A is a gap formed at a position through which illumination light from the observation optical system 12 and beams sufficient for observing can pass. The upper illuminator 21 has a light emitting element, such as an LED (light emitting diode), a scattering plate and serves as a surface light source having a ring-shaped light emitting surface 21B disposed below. The outer appearance of the upper illuminator 21 is sufficiently larger than the first mirror 14, and illumination light emitted from the upper illuminator 21 illuminates a observation position P1 of the peripheral edge of the wafer W and the periphery over a wide range from above.

The lower illuminator 22 is disposed to be lower than the wafer W and the lower second mirror 15B by a predetermined distance in side view and is fixed to the slider 4A of the Z stage 4. The lower illuminator 22 has a light-emitting element and a scattering plate and serves as a surface light source having a rectangular light emitting surface 22B formed above. The outer appearance of the lower illuminator 22 is sufficiently larger than the first mirror 14, and illumination light emitted from the lower illuminator 22 illuminates the observation position of the peripheral edge of the wafer W and the periphery over a wide range from below.

The side illuminator 23 is disposed at a rear surface side of the first mirror 14 and is fixed to the fixed portion 11. The side illuminator 23 extends downward from the lower second mirror 15B and upward from the upper second mirror 15A and has a rectangular light emitting surface 23B formed by a light emitting element and a scattering plate. The illumination light emitted from the side illuminator 23 illuminates the peripheral edge of the wafer W over a wide range from a radial outer side.

Thus, since a configuration surrounded by the light emitting surfaces from three directions is adopted, it is possible to illuminate the peripheral edge of the wafer W from almost all directions. Accordingly, even if the radial sectional shape of the wafer W changes according to a lot, it is possible to cope with the changed situation. In addition, if there is room in a space, another surface light source may be further provided in a surface (that is, a surface parallel to the plane of FIG. 1) perpendicular to each of the three illuminators 21 to 23 with the first mirror 14 interposed therebetween. In addition, a mirror may also be disposed instead of the surface light source. In addition, other than an LED, an organic EL or a backlight of a liquid crystal display may also be adopted as the surface light source as long as sufficient brightness is obtained.

Furthermore, as shown in FIG. 2, the peripheral edge illuminating device 6 includes a pair of inclined illuminators (oblique illumination portions) 31 provided between the XYθ stage 3 and the first mirror 14. Each of the inclined illuminators 31 is fixed to an arm 32 with an optical axis of the epi-illumination portion 60 and the optical axis of the observation optical system 12 bent at the first mirror 14 interposed therebetween. Each of the inclined illuminators 31 includes a plurality of LEDs and is disposed such that each LED 31A illuminates the observation position P1 of the peripheral edge of the wafer W in an inclined manner. Each of the inclined illuminators 31 is disposed more adjacent to the wafer W than the first mirror 14 or other illuminators 21, 22, and 23 are and spotlights the wafer W. The inclined illuminators 31 are disposed approximately on the same plane as the horizontal axis of the wafer W. By performing inclined/oblique illumination from two directions, particularly a state where only one of two straight line portions of a notch becomes a shadow can be prevented. Accordingly, illumination can be uniformly performed.

The arm 32 that supports the inclined illuminators 31 is bent so as to avoid a space 25 surrounded by the three illuminators 21, 22, and 23 and extends to a rear surface of the fixed portion 11 to be rotatably attached to the fixed portion 11. As shown in FIG. 1, the arm 32 is connected to a cylinder 35, and accordingly, a pair of-arms 32 can be driven so as to be opened and closed. When the pair of arms 32 is closed, each of the inclined illuminators 31 moves to the illumination position where the wafer W is illuminated. When the pair of arms 32 is opened, each of the inclined illuminators 31 moves to a waiting position retreated from the space 25 surrounded by the three illuminators 21 to 23.

Moreover, as shown in FIGS. 2,3, and 7, the peripheral edge illuminating device 6 includes a pair of bar illuminators 41A and 41B disposed such that upper and lower sides of the wafer W are interposed therebetween. The bar illuminators 41A and 41B are fixed to a support portion 42 extending from the slider 4A. In plan view, the bar illuminators 41A and 41B extend thin and long in a direction perpendicular to an axial line that connects a observing point on the wafer W and the first mirror 14, and the angle of a light emitting surface 43 is adjusted such that illumination light is directed toward the observation position P1. Each of the bar illuminators 41A and 41B has a diffusion plate and a light emitting element provided in a line in a longitudinal direction and illuminates the observation position P1 and the periphery over a wide range. In addition, an illuminator having a shape of a lot rod that diffuses light guided by a fiber may be used.

In addition, as shown in FIG. 1, the visual inspection apparatus 1 is provided with a control device 51, a lighting source 52, and an input device 53. The control device 51 is connected so as to be able to control each of the stages 3 and 4, the observation optical system 12, the imaging portion 13, the first mirror 14, the peripheral edge illuminating device 6, and the arm 32. The lighting source 52 can adjust lighting of light sources and the light amount of the epi-illumination portion 60 and the peripheral edge illuminating device 6. Since the input device 53 receives an inspector's operation, a button, a switch, a joystick (not shown), and the like are provided. A general-purpose personal computer may also be used as the input device 53 and the control device 51.

Next, an operation of the embodiment will be described.

In an initial state, the XYθ stage 3 moves horizontally from the position shown in FIG. 1 and waits at a wafer receiving position distant from the peripheral edge observation device 5. The inclined illuminator 31 of the peripheral edge illuminating device 6 is disposed at a waiting position outside the space 25.

The wafer W is first mounted on the XYθ stage 3. The wafer W is conveyed by a robot (not shown), for example, in a state where the wafer W is aligned beforehand by an alignment device and is positioned and placed on the XYθ stage 3. When the XYθ stage 3 absorbs and holds a middle part of a bottom surface of the wafer W, the inspection starts according to a command of the control device 51.

When the inspection starts, the XYθ stage 3 moves horizontally and the Z stage 4 is driven as needed, such that the position of the peripheral edge observation device 5 is adjusted to become an optimal position for observing the wafer W. When the movement of wafer W is completed, the pair of arms 32 are made to rotate by the cylinder 35 and the inclined illuminator 31, which was retreated beforehand so as not to be obstructed at the time of movement of the wafer W, moves to the illumination position shown in FIG. 2.

The peripheral edge of the wafer W illuminated by the epi-illumination portion 60 and the peripheral edge illuminating device 6 is observed by using the peripheral edge observation device 5. The upper illuminator 21 of the peripheral edge illuminating device 6 illuminates the wafer W over a wide range from above. The lower illuminator 22 illuminates the wafer W over a wide range from below. The side illuminator 23 illuminates the wafer over a wide range from the side direction. Since these illuminators 21 to 23 have sufficiently large sizes, a sufficient amount of illumination light reaches the observation position P1 even if illumination light is blocked by the first mirror 14, the second mirrors 15A and 15B, and the inclined illuminators 31.

The bar illuminators 41A and 41B illuminate the wafer W over a wide range from an angle different from the three illuminators 21 to 23. The inclined illuminator 31 illuminates the observation position in a spot manner. In the case when a notch of the wafer W is present at the observation position, a recessed portion of the notch becomes a shadow easily. However, the recess of the notch becomes bright without becoming a shadow by causing the inclined illuminators 31 to perform illumination from the inclined direction.

The epi-illumination portion 60 illuminates the position changing with the angle of the first mirror 14. When observing a side surface of the peripheral edge of the wafer W positioned at the observation position P1, the inclination angle of the first mirror 14 is set to 45° by operating the input device 53, for example, as shown in FIG. 3. The illumination light of the epi-illumination portion 60 is refracted and reflected by the first mirror 14 and illuminates the side surface of the peripheral edge of the wafer W positioned at the observation position P1. Since the peripheral edge observation device 5 is disposed at the same axis as the epi-illumination portion 60, an image on the side surface of the peripheral edge of the wafer W positioned at the observation position P1 is obtained. Since the observation position P1 is illuminated by the peripheral edge illuminating device 6 in addition to the illumination performed by the epi-illumination portion 60, a bright image is obtained.

When observing an upper surface of the peripheral edge of the wafer W positioned at the observation position P1, the rotating shaft 16B is driven by operating the input device 53, for example, as shown in FIG. 5, and setting to a first angle and position is made such that the first mirror 14 is turned to the upper second mirror 15A. Thus, illumination light of the epi-illumination portion 60 is refracted and reflected by the first mirror 14 and is incident on the upper second mirror 15A. Then, the illumination light is refracted and reflected by the second mirror 15A and propagates toward the upper surface of the peripheral edge of the wafer W to illuminate the portion. The peripheral edge observation device 5 obtains an image on the upper surface of the peripheral edge of the wafer W brightly illuminated by the epi-illumination portion 60 and the peripheral edge illuminating device 6.

When observing a low surface of the peripheral edge of the wafer W positioned at the observation position P1, the rotating shaft 16B is driven by operating the input device 53, for example, as shown in FIG. 6, and setting to a second angle and position is made such that the first mirror 14 is turned to the lower second mirror 15B. Thus, illumination light of the epi-illumination portion 60 is refracted and reflected by the first mirror 14 and is incident on the lower second mirror 15B. Then, the illumination light is refracted and reflected by the second mirror 15B and propagates toward the lower surface of the peripheral edge of the wafer W to illuminate the portion. The peripheral edge observation device 5 obtains an image on the lower surface of the peripheral edge of the wafer W brightly illuminated by the epi-illumination portion 60 and the peripheral edge illuminating device 6.

When the first mirror 14 is set at an angle in a range of 45° to the first angle, a predetermined position is illuminated until reaching the upper surface from the side surface of the observation position of the wafer W and an image at the corresponding position is obtained. When the first mirror 14 is set at an angle in a range of 45° to the second angle, a predetermined position is illuminated until reaching the lower surface from the side surface of the observation position of the wafer W and an image at the corresponding position is obtained.

When performing observing, the inspector observes the peripheral edge of the wafer W while operating the peripheral edge observation device 5 or the lighting source 52 with the input device 53. The peripheral edge observation device 5 has a magnification changing function. When the zoom magnification is raised, the control device 51 applies a coefficient registered beforehand to increase the light amount of all illumination.

When the inspector desires to observe the wafer W in a bright field, all of the illumination of the epi-illumination portion 60 and the peripheral edge illuminating device 6 are lighted and a light control is made as needed. In particular, it is preferable to further make a fine adjustment of the epi-illumination portion 60 and the upper illuminator 21 while viewing an image of the peripheral edge observation device 5. Accordingly, even when the observation angle of the wafer W or the type of the wafer W and the zoom magnification changes, it is possible to obtain satisfactory bright field illumination by making the entire portion bright. As a result, a clear bright field image can be obtained. An operation becomes easy when fine adjustment of the epi-illumination portion 60 and the upper illuminator 21 is performed by increasing or decreasing the amount of light with a switch provided in the input device 53. The inspector may easily observe the amount of light by providing a display unit that displays the amount of light, for example, a rate with respect to the maximum amount of light, near the switch.

When the inspector desires to observe the wafer W in a dark field, all portions excluding the inclined illuminators 31 and the bar illuminators 41A, and 41B are turned off. Light from each of the bar illuminators 41A and 41B is controlled according to the observation angle of the wafer W and the light may be turned off if needed. Accordingly, best dark field illumination is obtained according to the observation angle of the wafer W or the type of the wafer W and the zoom magnification. As a result, a clear dark field image can be obtained.

Here, a one-touch switching operation can be performed by providing a button for switching between observing in a bright field and observing in a dark field in the input device 53. A table 51A, in which illuminators turned on in each of the bright field and the dark field and the light amount at the time of a rough light control correspond to each other as initial values, may be provided in the control device 51 so that switching of illumination can be performed on the basis of the table 51A. In this case, when the bright field and the dark field are switched, automatic light control of each illumination is performed on the basis of the table 51A. A fine adjustment may be made as needed by operating the input device 53 in this state. A troublesome rough light control operation can be omitted by providing the table 51A.

The table 51 A may store data of the amount of light when performing a rough light control for every zoom magnification. This makes it possible to quickly respond to a change in zoom magnification. In addition, a table may also be generated according to the angle of the observation position or the type of wafer.

TABLE 1 illustrates a table of light amount control as an example of the aforesaid table 51A.

TABLE 1

| | | Observation Angle | | | | | | | | | |
|---|---|---|---|---|---|---|---|---|---|---|---|
| | | 90 deg. | | 45 deg. | | 0 deg. | | −45 deg. | | −90 deg. | |
| Illumination | | Observation Magnification | | | | | | | | | |
| Name | | ×0.5 | ×5 | ×0.5 | ×5 | ×0.5 | ×5 | ×0.5 | ×5 | ×0.5 | ×5 |
| Coaxial | Light | 50 | 70 | 30 | 70 | 20 | 40 | 30 | 70 | 50 | 70 |
| Illumination | Amount | | | | | | | | | | |
| Oblique | of | 60 | 90 | 60 | 90 | 60 | 80 | 60 | 90 | 60 | 90 |
| Illumination | Illumination | | | | | | | | | | |
| (Upper) | (%) | 30 | 40 | 20 | 50 | 15 | 30 | 20 | 50 | 30 | 40 |
| Surface Light | | | | | | | | | | | |
| Source | | | | | | | | | | | |
| (Side) | | 100 | 100 | 80 | 80 | 80 | 80 | 80 | 80 | 100 | 100 |
| Surface Light | | | | | | | | | | | |
| Source | | | | | | | | | | | |
| (Lower) | | 80 | 90 | 80 | 90 | 70 | 70 | 80 | 90 | 80 | 90 |
| Surface Light | | | | | | | | | | | |
| Source | | | | | | | | | | | |
| (Upper) | | 40 | 90 | 90 | 90 | 60 | 90 | 90 | 90 | 40 | 90 |
| Bar | | | | | | | | | | | |
| Illumination | | | | | | | | | | | |
| (Lower) | | 0 | 0 | 0 | 0 | 60 | 90 | 0 | 0 | 0 | 0 |
| Bar | | | | | | | | | | | |
| Illumination | | | | | | | | | | | |

The visual inspection performed as described above is executed while moving the peripheral edge, which needs to be inspected, to the observation position P1 one by one by rotating the XYθ stage 3. When the inspection on a required place is completed, the inclined illuminator 31 is moved to waiting position by opening the pair of arms 32 by driving the cylinder 35. After moving the XYθ stage 3 to the wafer delivery position, absorption and holding of the wafer W is released and the inspected wafer W is taken out by a robot.

According to this embodiment, since a plurality of illuminators are disposed such that the light control can be made and the wafer W is illuminated from different directions, the wafer W can be brightly illuminated in the wide range. As a result, a clear image can be obtained even if the observation position changes. Since the illuminators 21 to 23 of the peripheral edge illuminating device 6 are formed by using large-sized surface light sources, the wafer W disposed at the observation position P1 can be illuminated sufficiently brightly even if the first mirror 14 or the inclined illuminator 31 is disposed in the space 25.

Since an observing condition can be simply adjusted by controlling the plurality of illuminators, a clear image can be obtained not only in a bright field but also in a dark field.

Since the rotary second mirrors 15A and 15B and the first mirror 14 rotatable and movable integrally with the observation optical system 12 are provided in the peripheral edge observation device 5, it is possible to change the observation position without largely rotating or moving the CCD camera 13B. Accordingly, it is possible to make the apparatus configuration simple and small.

Since each of the illuminators 21 to 23 has a flat shape in the peripheral edge observation device 5, versatility is high and apparatus cost can be reduced unlike the known C-shaped optical component.

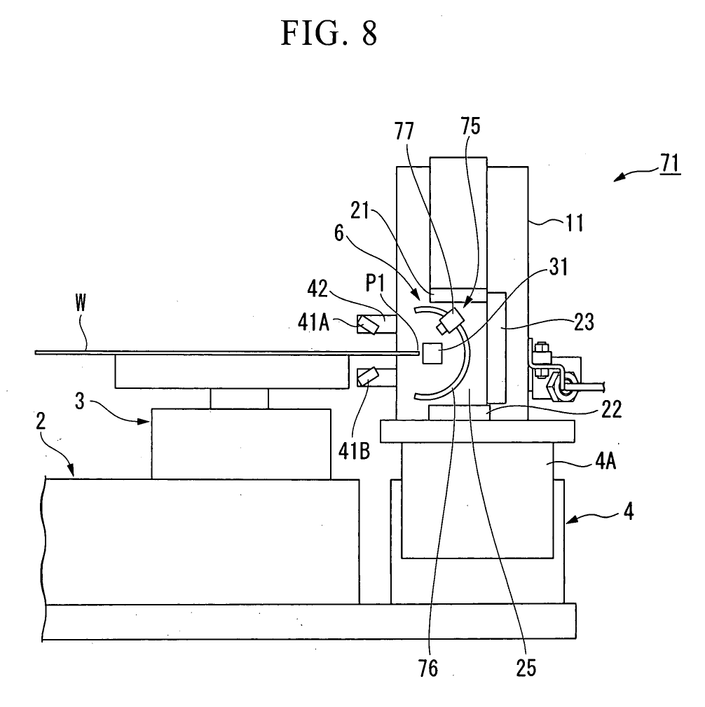

A modified example is shown in FIG. 8. A visual inspection apparatus 71 is characterized in that a peripheral edge observation device 75 is disposed within a space 25 that a peripheral edge illuminating device 6 forms. The peripheral edge observation device 75 has a configuration in which a CCD camera 77 is attached to an approximately C-shaped rail 76, which has the observation position P1 as a center, so as to move freely. The peripheral edge illuminating device 6 has the same configuration except that first and second mirrors are not provided. At the time of observing, a desired position is observed while moving the CCD camera 77 along the rail 76. Switching of the light amount of illuminators is performed in the same manner as described above, and observing is performed in a bright field or in a dark field. In the case of disposing the CCD camera outside the illuminating device in the same manner as the known art, it was necessary to provide a hole or a gap in the illuminator in order to secure a field of view of the CCD camera In addition, since the distance from the CCD camera to a wafer was long, the moving distance of the CCD camera was long. On the other hand, in the visual inspection apparatus 71, the CCD camera 77 can be disposed adjacent to the wafer W. Accordingly, it is possible to make the apparatus configuration simple and small. The visual inspection apparatus 71 may be of a multi-eye type with two or more CCD cameras 77.

In addition, the invention may be widely applied without being limited to the above embodiment.

For example, although the visual inspection apparatus 1 may be used independently, the visual inspection apparatus 1 may also be used by being attached to micro-test equipment that tests a surface of a wafer using a microscope. In this case, the base 2 and the XYθ stage 3 are shared by the micro-test equipment. In addition, the visual inspection apparatus 1 may also be used by being attached to macro-test equipment that visually inspects a surface of a wafer. The visual inspection apparatus 1 may also be used by being attached to test equipment provided with micro-test equipment and macro-test equipment.

The table 51A of the control device 51 is not an essential component.

The appearance of the upper illuminator 21 is not limited to the ring shape. The gap provided in the upper illuminator 21 preferably allows illumination light from the observation optical system 12 and beams required for observation to pass therethrough and is not limited to the hole 21A. The peripheral edge observation device 5 may also be disposed at a rear surface side of the lower illuminator 22 or the side illuminator 23. In this case, a gap through which illumination light of the observation optical system 12 is transmitted is formed in the illuminators 22 and 23 where the peripheral edge observation device 5 is disposed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A visual inspection apparatus comprising:
a peripheral edge observation device that observes a peripheral edge of a work supported by a support portion; and
a peripheral edge illuminating device that illuminates a position of observing performed by the peripheral edge observation device,
wherein the peripheral edge illuminating device includes a plurality of surface light sources that illuminate the peripheral edge of the work located at the observation position, and
the surface light sources are disposed at upper, lower, and side positions from the peripheral edge of the work located at the observation position so as to surround the peripheral edge of the work.

2. The visual inspection apparatus as recited in claim 1,
wherein the peripheral edge observation device includes an optical member disposed in a space surrounded by the surface light sources, and
each of the surface light sources includes a light emitting surface larger than the optical member.

3. The visual inspection apparatus as recited in claim 2,
wherein illumination light provided by each of the surface light sources has a size enough to reach the observation position when observing the peripheral edge of the work with the peripheral edge observation device.

4. The visual inspection apparatus as recited in claim 1,
wherein in the peripheral edge observation device, an optical member disposed closest to the peripheral edge of the work is disposed closer to the peripheral edge of the work than the plurality of surface light sources.

5. The visual inspection apparatus as recited in claim 4,
wherein the optical member includes a mirror.

6. The visual inspection apparatus as recited in claim 1,
wherein the surface light source has a gap, which allows light to be transmitted therethrough, provided in accordance with an optical axis position of the peripheral edge observation device.

7. The visual inspection apparatus as recited in claim 1,
wherein the peripheral edge illuminating device includes a pair of bar illuminators disposed such that upper and lower sides of the work are interposed therebetween.

8. The visual inspection apparatus as recited in claim 1,
wherein the peripheral edge illuminating device includes an inclined illuminator that retreats so as not to be obstructed at the time of movement of the work and that spotlights the observation position.

9. The visual inspection apparatus as recited in claim 1, further comprising:
a control device capable of controlling the peripheral edge illuminating device,
wherein the control device has a table, in which illuminators turned on in each of a bright field and a dark field and a light amount at the time of a rough light control correspond to each other as initial values, and switching of illumination is performed on the basis of the table.

10. The visual inspection apparatus as recited in claim 1, further comprising:
a control device capable of controlling the peripheral edge illuminating device,
wherein the control device has a table in which data of a light amount when performing a rough light control for every zoom magnification is stored.
